(19) United States
(12) Patent Application Publication
(10) Pub. No.: US 2004/0194324 A1
(43) Pub. Date: Oct. 7, 2004

(54) Tool head fixer

(76) Inventor: Liao Youn-Chyuan, Taichung (TW)

Correspondence Address: CHARLES E. BAXLEY, ESQ., 90 JOHN STREET, THIRD FLOOR, NEW YORK, NY, 10038, US

(21) Appl. No.: 10/772,731

(22) Filed: Feb. 4, 2004

(30) Foreign Application Priority Data
Apr. 7, 2003 (CN) 092205509

(51) Int. Cl. B27B 19/09

(52) U.S. Cl. 30/337; 30/338; 30/392

(57) ABSTRACT

The present invention relates to a tool head fixer with pressing effect and of wide applications. It mainly comprises a shaft, a rotating socket and a stopping ring, the shaft having a insertion groove in the middle of its front end for inserting a tool head, a pressing bolt with a reposition spring is disposed at the circumference of the shaft, the shaft is inserted and disposed inside the rotating socket and is positioned by the stopping ring, the rotating socket having an acentric groove in corresponding to the pressing bolt, the rotating socket can activate the pressing bolt to press against or relieve the tool head, thus the tool head can be easily and conveniently changed and is firmly fixed, at the same time it is convenient to operate and can be widely used for various applications.

### BACKGROUND OF THE INVENTION

The present invention relates to a tool head fixer for fixing various kinds of tools. A rotating socket having an acentric groove to activate a pressing bolt to press against or relieve the head. The pressing bolt having a reposition spring, so that tool heads can be easily changed and speedily fixed to enhance operation efficiency and can be widely used for various applications.

A tool head fixer is used to connect various tool heads on a shaft handle in order to minimize the size of the tool for ease of carrying and convenience of operation. Referring to FIG. 1, a conventional tool head 20 and a fixer 10, the fixer 10 comprises an insertion groove 12 and a shaft 11, another end of the shaft 11 having a connecting shaft 13 for inserting into a handle. The shaft 11 having an outer socket 15 sleeving on it, the outer socket 15 and the shaft 11 having a screw hole 16 which is connected to the insertion groove 12, the screw hole 16 is for a bolt 17 to screw and lock on. Then insert the tool head 20 of an insertion section 21 inside the insertion groove 12 of the shaft 11 of the fixer 10. A fixing hole 22 is disposed on the insertion section 21 in corresponding to the screw hole 16, so that users can turn the bolt 17 to press against or relieve the tool head 20.

However, the conventional fixer 10 has some problems on its design. Users cannot fix or change the tool head 20 without using a screwdriver to turn the bolt 17. It is somewhat inconvenient and also dangerous if the tool head 20 get loosed because of vibration caused during operation, especially when a saw blade is used as the tool head 20.

Besides, another conventional tool head fixer is U.S. Pat. No. 6209208B1, which we call it a second prior art. The second prior art comprises a handle and a knife tool fixer. One end of the knife tool fixer can be sleeved on the handle, and its another end is for connecting a blade. The knife tool fixer comprises a shaft, a stopping cap, an elastic element, a rotating socket, a fixing pin, a rotating base and a rotating cap. One end of the shaft having a first shaft section for connecting to the handle, while the other end having a second shaft section for connecting to the stopping cap, the elastic element, the rotating socket, the rotating base and the rotating cap. A locking groove is disposed along the longitudinal axis of the second shaft section at a suitable location for connecting to the blade, and a fixing axial hole is also disposed on the second shaft section and is connecting to the locking groove perpendicularly. Accordingly, when the rotating cap is turned, it activate the rotating base to turn also, so that the fixing pin moves upward to escape from the locking groove, for users to change the blade. If the rotating force stops, the elastic element will bounces back from being pressed by the rotating force previously, so that the rotating cap returns back to its position and make the locking pin to press against the blade again.

Even though the second prior art does not have obvious drawbacks, it comprises too many elements and its structure is somewhat complicated. The production cost is thus more expensive. Two corresponding locking grooves are disposed on the rotating base for inserting the elastic element, the rotating groove is disposed on its side, a slant surface like a bent blade is disposed on the side of the rotating groove. The rotating cap having two locking pieces inside for connecting to the rotating base, a locking ring is used for fixing purpose. The elastic element having a movable end on its each end for connecting to the rotating base and shaft individually. It has too many elements and make the production cost more expensive. In additional, when users need to change the blade, the displacement of the rotating base is achieved by the elasticity of the elastic element, if the elastic element loses it elasticity, it will affect the overall operation.

### SUMMARY OF THE INVENTION

The present invention of a tool head fixer mainly comprises a shaft, a rotating socket and a stopping ring.

The shaft having an insertion groove disposed on its front end, a hole is disposed on the circumference of the shaft, which the hole is connected, and perpendicular to the insertion groove. Another end of the shaft having a ring groove for an E-shaped lock to lock onto. The shaft having a connecting shaft section protruded outside from its rear end, and a concave groove is disposed on the connecting shaft section. A T-shape pressing bolt is inserted into the hole of the shaft, a conical reposition spring is sleeved on the pressing bolt.

The rotating socket having a hole is pivotally sleeved on the shaft, the rotating socket having an acentric groove disposed at its center in corresponding to the pressing bolt of the shaft. The stopping ring is sleeved on the end of the shaft that goes through the hole of the rotating socket.

Accordingly, by rotating the rotating socket to make the pressing bolt press against or release the tool head. The automatic reposition mechanism can further provide a firm hold on the tool head to enhance safety. The present invention also having less elements and simple structure to reduce the production cost to the minimum.

The present invention will become more fully understood by reference to the following detailed description thereof when read in conjunction with the attached drawings.

### BRIEF DESCRIPTION OF THE DRAWINGS

FIG. 1 is a perspective view of a prior art of a tool head fixer;

FIG. 2 is a perspective exploded view of the present invention, showing the different elements and their connections;

FIG. 3 is a perspective assembly view of the present invention, showing the connections of the elements;

FIG. 4 is a sectional assembly view of the present invention, showing the connections of the elements;

FIG. 5 is a sectional view of the present invention, showing the structure after being pressed (A) and before being pressed (B);

FIG. 6 is a perspective view of the present invention being used;

FIG. 7 is a perspective exploded view of another embodiment of the present invention;

FIG. 8 is a perspective assembly view of another embodiment of the present invention;

FIG. 9 is sectional view of another embodiment of the present invention;

FIG. 10 is perspective view of another embodiment of the present invention being used.

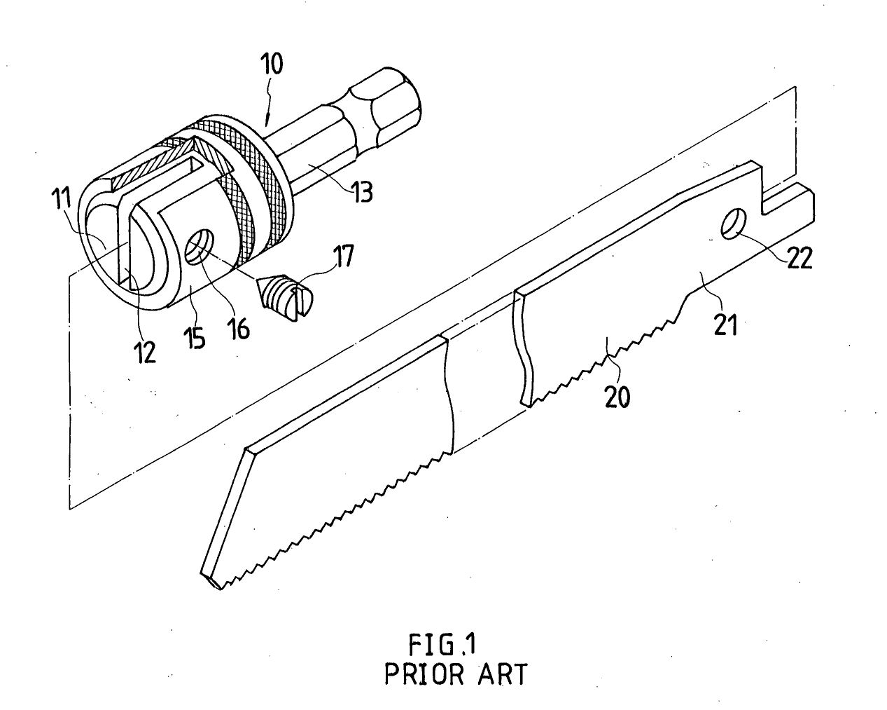

### DETAILED DESCRIPTION OF THE PREFERRED EMBODIMENT

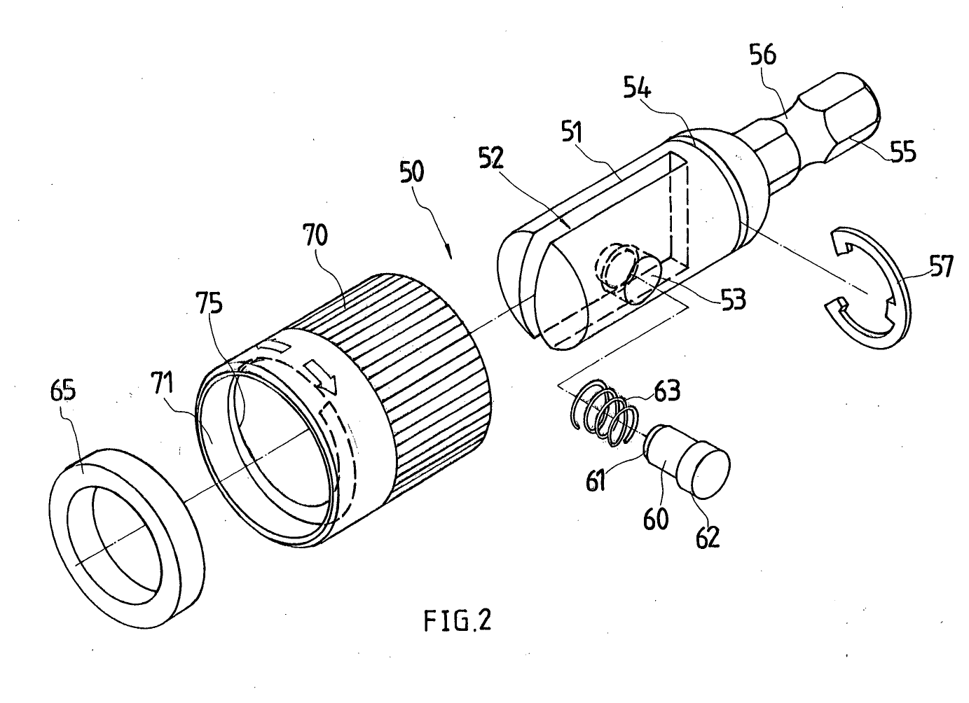

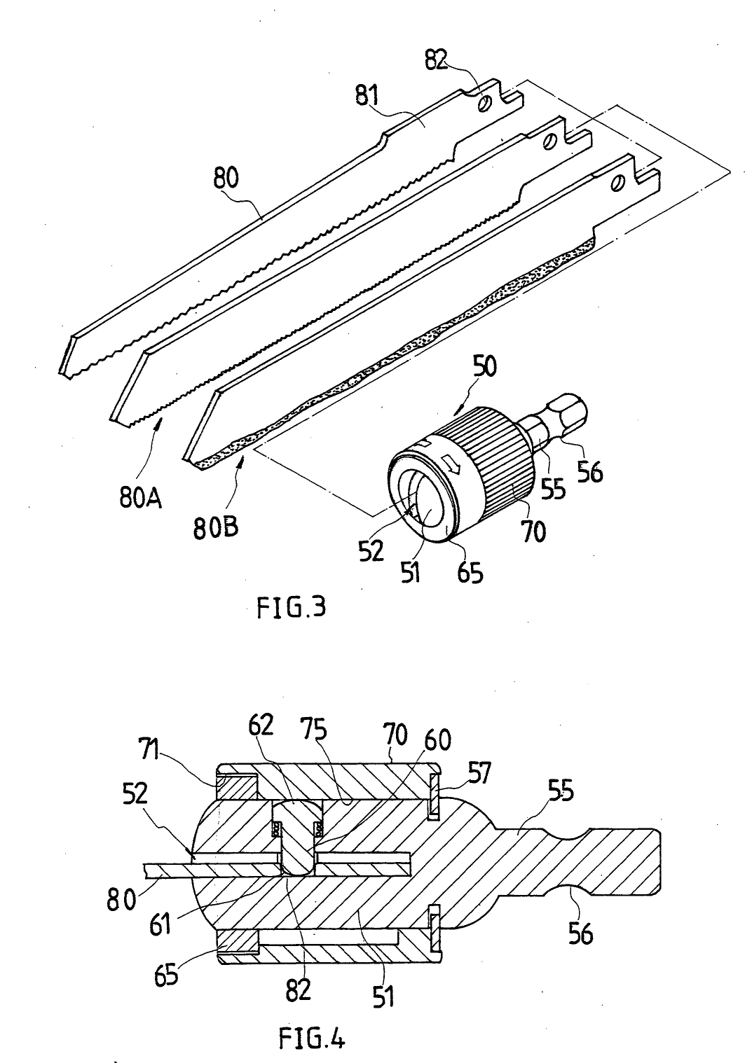

Referring to FIGS. 2 and 3, a tool head fixer 50 mainly comprises a shaft 51, a rotating socket 70 and a stopping ring 65. The shaft 51 is inserted into the rotating socket 70 and is limited by the stopping ring 65, so that a tool head 80 can be inserted into the tool head fixer 50

Referring FIGS. 2, 3 and 4, the front end of the shaft 51 having an insertion groove 52, the circumference of the shaft 51 having a step-shaped hole 53 connected and perpendicular to the insertion groove 52. Another end of the shaft 51 having a locking groove 54, the rear end of the shaft 51 having a connecting shaft section 55 protruded outward for inserting in various handles, the shaft section 55 is in multi-angular shape, it also having a fixing groove 56 disposed on its central section for locking and fixing purpose. The locking groove 54 of the shaft 51 is for an E-shaped lock 57 to lock on, the hole 53 having a T-shaped pressing bolt 60 inserted inside, the pressing bolt 60 is in step-shaped. The pressing bolt 60 having a conical part 61 in corresponding to the insertion groove 52. A round head end 62 is disposed on the another end of the pressing bolt 60. A conical reposition spring 63 is inserted onto the pressing bolt 60, the round head end 62 can press against on the spring 63 to let it return back to its original position.

The shaft 51 having the rotating socket 70 sleeving on it, the rotating socket 70 having a connecting hole 71 disposed on the center along its axis, the connecting hole 71 having an acentric groove 75 in corresponding to the pressing bolt 60 of the shaft 51. So that the pressing bolt 60 is moved by the rotating socket 70 in and out of the corresponding insertion groove 52. The shaft 51 having the stopping ring 65 disposed on the end that goes through the connecting hole 71 of the rotating socket 70. The rotating socket 70 is sleeved on the shaft 51.

Accordingly, the insertion groove 52 of the shaft 51 can fit various types of the tool head 80, 80A and 80B. Various types of the tool head 80 are inserted into the insertion section 81 of the insertion groove 52 of the shaft 51. The insertion section 81 having fixing hole 82 in corresponding to the pressing bolt 60 of the shaft 51. The structure is simple and can provide ease of operation and firm hold on the tool head.

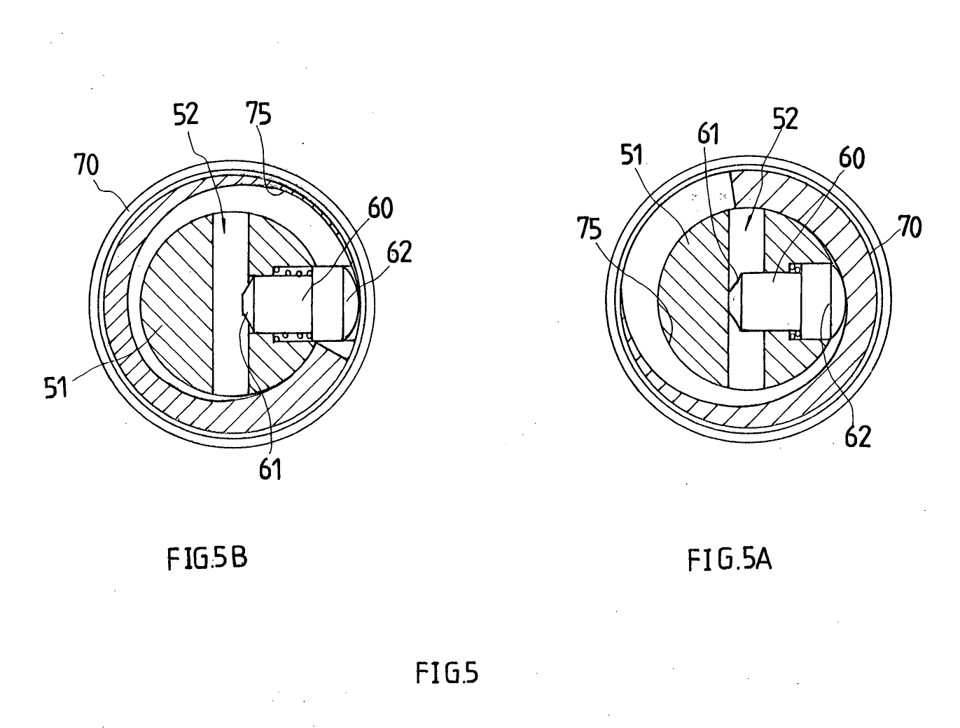

Referring to FIGS. 3, 4 and 5, turn the rotating socket 70 so that the thicker side of the acentric groove 75 corresponds to the pressing bolt 60, to press the pressing bolt 60 into the insertion groove 52 as shown on FIG. 5A. When users need to insert the tool head 80, just simply turn the rotating socket 70 towards the thinner side of the acentric groove 75, so that the pressing bolt 60 of the shaft 51 will move outward because of the elasticity of the reposition spring 63 as shown on FIG. 5B. Finally, the tool head 80 is inserted into the insertion groove 52 of the shaft 51, so that the fixing hole 82 of the tool head 80 is corresponding to the pressing bolt 60. When users turn the rotating socket 70 in the opposite direction to return it back to its original position, the conical part 61 of the pressing bolt 60 presses against the fixing hole 82 of the tool head 80, so as to stably fix the tool head 80.

Thus the tool head 80 can be inserted or changed without using any other tools. The pressing bolt 60 does not easily get loosed during operation, because of the spring 63 is pressed against on the pressing bolt 60. So that safety is enhanced and the tool head 80 is firmly fixed in position.

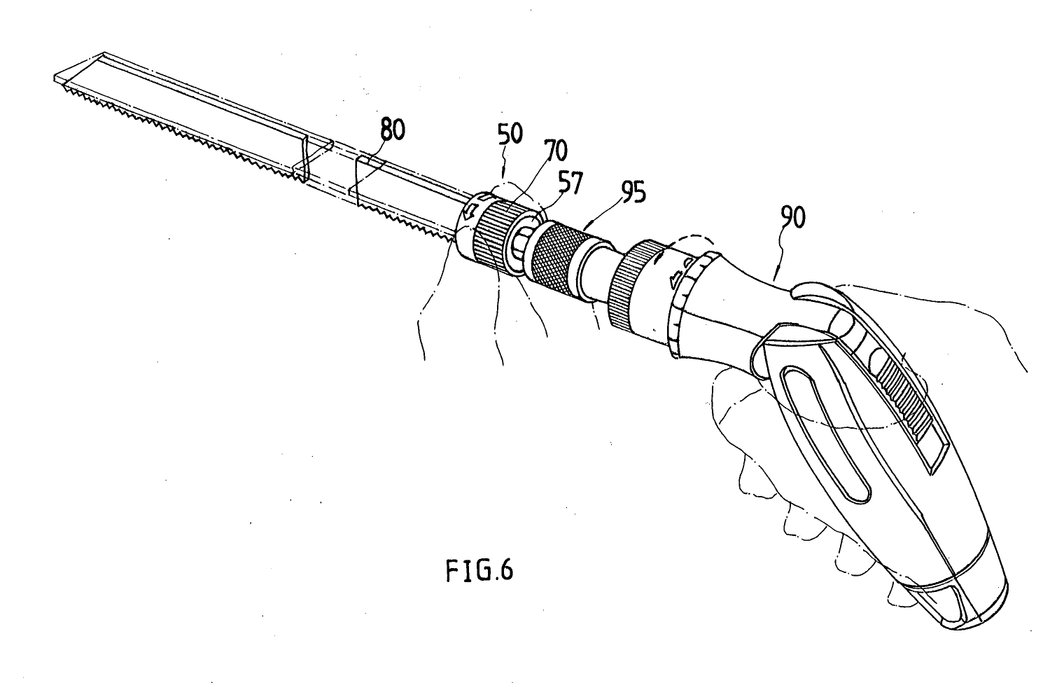

Referring to FIG. 6, the shaft section 55 of the fixer 50 of the tool head 80 is connected to a ratchet socket 95 of a foldable handle 90, so that users can adjust the holding angles and the angles of the tool head 80 to enhance the convenience of the operation.

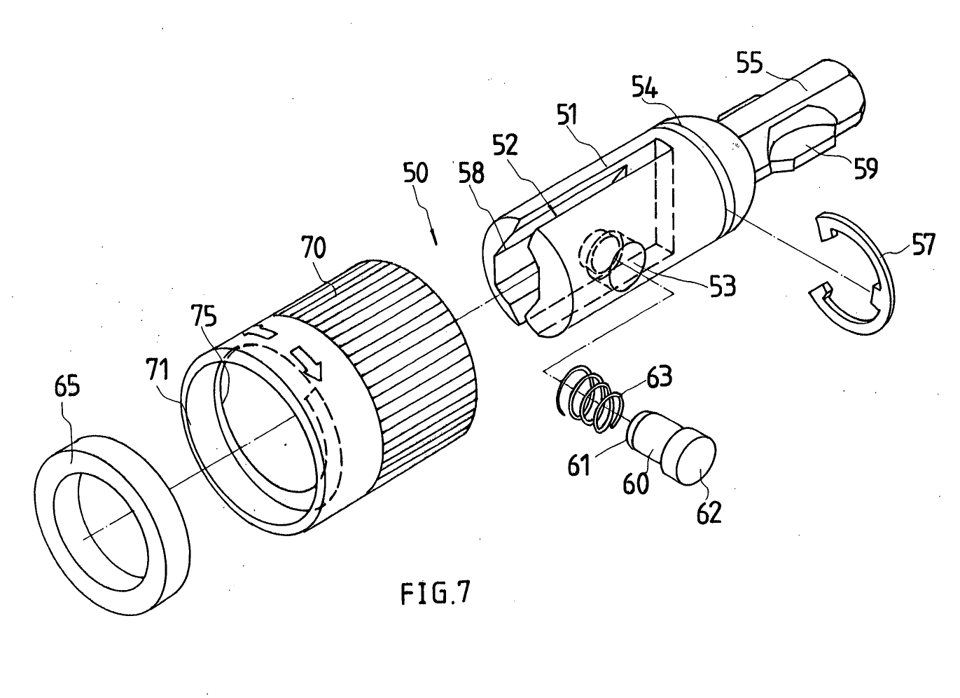

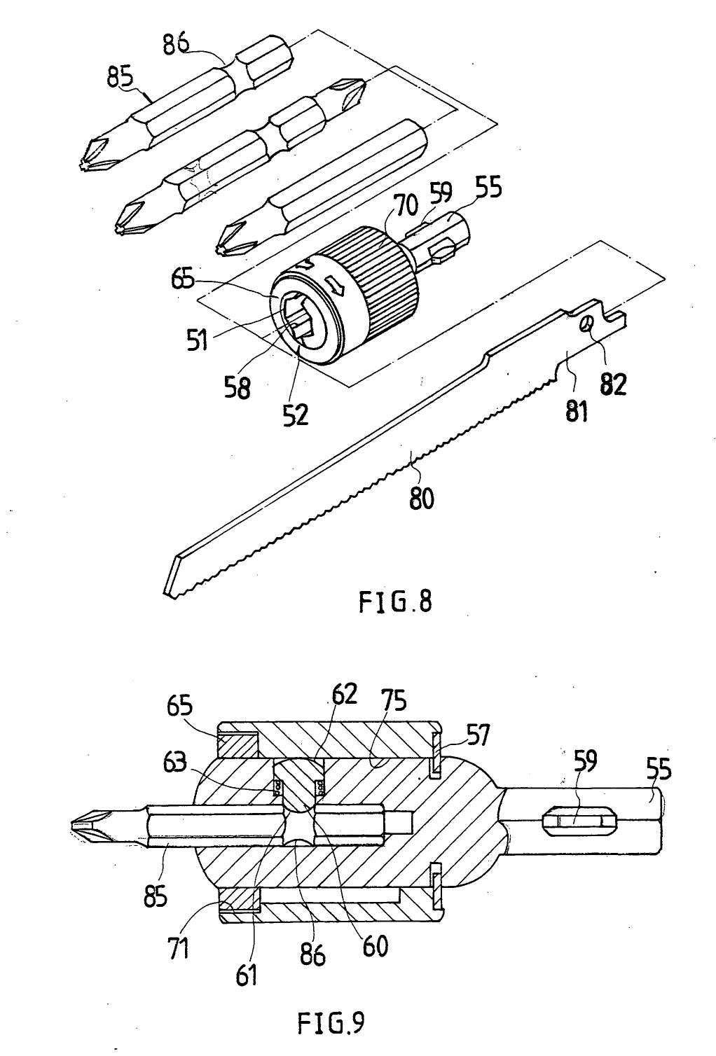

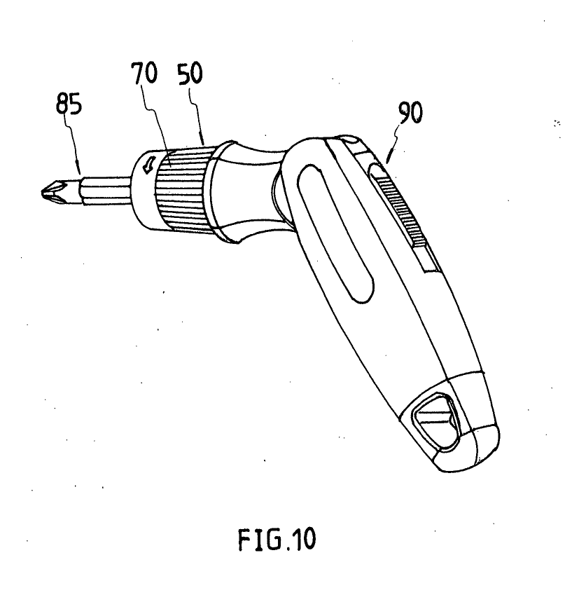

Referring to FIGS. 7, 8 and 9, the shaft 51 of the fixer 50 having a multi-angular insertion groove 58 disposed on its center, for inserting the tool head 85. A stopping groove 86 is disposed on the tool head 85 in corresponding to the circumference of the pressing bolt 60, for the pressing bolt 60 to press against on. The shaft section 55 of the shaft 51 having a locking piece 59 protruded outward from the central section of the shaft section 55, so that when the fixer 50 si inserted into the handle, it will not turn freely to coordinate with the screwing operation of the tool head 85. The fixer 50 can alos be inserted into the foldable handle 90 for ease of operation as shown on FIGS. 10.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

1-45. (cancelled)

46. A method for imaging of lymphatic vasculature in tissue, comprising the step of contacting the tissue with an antibody which interferes with binding of VEGF-D to a VEGF receptor-3, and detecting the occurrence of binding of said antibody.

47. A method according to claim 46, wherein said antibody is a monoclonal antibody selected from the group consisting of 2F8 (ATCC No. PTA-3653), 4A5 (ATCC No. HB-12698), 4E10 (ATCC No. PTA-3652), and 5F12 (ATCC No. PTA-3651), or a F(ab′)₂, F(ab′), F(ab) fragment or chimeric antibody thereof.

48. A method according to claim 46, wherein the antibody is labeled covalently or noncovalently with a detectable label.

49. A method according to claim 49, wherein the detectable label is selected from the group consisting of supermagnetic agent, a paramagnetic agent, an electron dense agent, an ecogenic agent, and a radioactive agent.

50. A method according to claim 49, wherein the detectable label is selected from the group consisting of ¹²⁵I, ³²P, an enzymatic label, and a fluorimetric labels.

51. A method according to claim 50, wherein the enzymetic label is horseradish peroxidase.

52. A method according to claim 50, wherein the fluorimetric label is fluorescein-5-isothiocyanate (FITC).

53. An antibody that specifically binds to a polypeptide having the amino acid sequence as set forth in SEQ ID NO:1.

54. The antibody according to claim 53, wherein said antibody is a monoclonal antibody, or a F(ab′)₂, F(ab′), F(ab) fragment or a chimeric antibody or a humanized antibody thereof.

55. The antibody according to claim 53, wherein said antibody is labeled with a detectable label.

56. The antibody according to claim 55, wherein said detectable label is a radioactive isotope.

57. The antibody according to claim 53, wherein said antibody is a human antibody.

58. An antibody which interferes with the activity of VEGF-D mediated by a VEGF receptor-2, wherein said antibody binds specifically to a polypeptide having an amino acid sequence set forth in SEQ ID NO: 1.

59. The antibody of claim 58, which is a monoclonal antibody or a F(ab′)₂, F(ab′), F(ab) fragment or a chimeric antibody or a humanized antibody thereof.

60. The antibody of claim 58, wherein said antibody does not interfere with the activity of VEGF mediated by a VEGF receptor-2.

61. The antibody according to claim 58, wherein said antibody does not bind to VEGF-C.

62. The antibody according to claim 58, wherein said antibody interferes with the binding of VEGF-D to a VEGF receptor-3.

63. A composition, comprising an antibody according to claim 58, and a pharmaceutically acceptable carrier.

64. An antibody which interferes with the activity of VEGF-D mediated by a VEGF receptor-3, wherein said antibody binds specifically to a polypeptide having an amino acid sequence set forth in SEQ ID NO: 1.
